(19) United States
(12) Patent Application Publication
(10) Pub. No.: US 2010/0067848 A1
(43) Pub. Date: Mar. 18, 2010

(54) FABRICATION METHOD OF OPTICAL MODULE AND OPTICAL MODULE USING THE SAME METHOD

(75) Inventors: SUNG HWAN HWANG, GWANGJU (KR); WOO JIN LEE, GWANGJU (KR); JUNG WOON LIM, GWANGJU (KR); BYUNG SUP RHO, GWANGJU (KR)

Correspondence Address: WPAT, PC, 2030 Main Street, Suite 1300, Irvine, CA, 92614, US

(73) Assignee: KOREA PHOTONICS TECHNOLOGY INSTITUTE, GWANGJU (KR)

(21) Appl. No.: 12/560,421

(22) Filed: Sep. 16, 2009

(30) Foreign Application Priority Data
Sep. 16, 2008 (KR) 10-2008-0090754

(51) Int. Cl. G02B 6/12; G02B 6/36

(52) U.S. Cl. 385/14; 385/88

(57) ABSTRACT

A fabrication method of an optical module comprises a mixed/hybrid optical alignment method, and an optical module uses the same fabrication method using an optical element chip such as a light source chip or a photodetector chip, etc. on an optical wiring substrate and making it possible to simultaneously secure mass productivity that is the advantage of the passive alignment method according to the related art and alignment accuracy that is the advantage of the active alignment method.

This application claims priority to Korean Patent Application No. 10-2008-0090754, filed on Sep. 16, 2008, in the Korean Intellectual Property Office, the entire contents of which are hereby incorporated by reference.

### BACKGROUND OF THE INVENTION

1. Field of the Invention

The present invention relates to a fabrication method of an optical module using an optical module packaging system. The fabrication method of an optical module comprises the optical alignment method that has features of an active optical alignment method and a passive optical alignment method by aligning optical elements on an optoelectronic wiring substrate including an optical waveguide.

2. Description of the Related Art

Recently, an active alignment method and a passive alignment method have been used as a method for fabricating an optical module.

In the active alignment method, a light source chip is bonded in a state where it is aligned with an optical waveguide to form an optimal optical coupling therewith in a state where the light source chip generates light by being applied with power.

More specifically, when a photodetector chip is aligned in the active alignment method, the photodetector chip is bonded on a position where it forms an optimal optical coupling with an optical waveguide in a state where the photodetector chip receives light by being applied with power and thus generates an electrical signal, such that external power should be applied to both the light source chip and the photodetector chip.

Therefore, in the active alignment method, the light source chip and the photodetector chip can be aligned with the optical waveguide only when they are electrically connected to an external light source, but this has a problem that a lot of additional apparatuses and conditions are required.

On the other hand, in the passive alignment method, the chip is bonded by recognizing an electrode or a mark on the position to which the chip is attached. Therefore, the passive alignment method is advantageous in view of mass production since an additional apparatus such as the external power supply used in the active alignment method is not required, but is disadvantageous in view of the difficulty in the optimal optical coupling between the optical element and the optical waveguide since there is a distance error between the central portion of the optical waveguide and the electrode or the mark on the position to which the optical element is attached.

Therefore, there is a demand for an alignment method, one of the processes of the fabrication method of an optical module, which can simultaneously perform the optimal optical coupling that is the advantage of the active alignment method and enable the mass production that is the advantage of the passive alignment method.

### SUMMARY OF THE INVENTION

A fabrication method of an optical module according to an embodiment of the invention is proposed to solve the above problems. A fabrication method of an optical module can provide a mixed/hybrid type of optical alignment method, that is, an active and passive optical alignment method that allows mass productivity and alignment accuracy of an optoelectronic wiring substrate, and an optical element packaging system and an optical module using the same.

The fabrication method of an optical module according to an embodiment of the invention, and an optical module using the same method add an external light source to a passive alignment method to set light emitted from the external light source to pass through an optical waveguide to an optical axis reference, making it possible to improve alignment accuracy that is the disadvantage of the passive alignment method.

According to an aspect of an embodiment of the invention, there is provided a fabrication method of an optical module comprising: aligning the center of a sort of optical element with the optical axis of the light transferred through an optical waveguide from an external light source and emitted to the outside of a substrate; bonding the optical element to the substrate; aligning the center of a different sort of optical element from the optical element with the optical axis of the incident light transferred through redundant optical waveguides formed around the optical waveguide having a predetermined distance from an external light source and emitted to the outside of the substrate; and moving the different sort of optical element up to the predetermined distance and bonding the different sort of optical element to the substrate which the optical waveguide is situated in.

Preferably, the optical element might be a light source chip and the different sort of optical element might be a photodetector chip, or the optical element might be a photodetector chip and the different sort of optical element might be a light source chip.

According to an aspect of an embodiment of the invention, there is provided a fabrication method of an optical module comprising: aligning the center of a sort of optical element with the optical axis of the light transferred through an optical waveguide from an external light source and emitted to the outside of a substrate; bonding the optical element to the substrate; applying power to the optical element and allowing the emitted light to be incident through the optical waveguide; aligning the center of a different sort of optical element from the optical element with the optical axis of the incident light emitted to the outside of the substrate; and bonding the different sort of optical element to the substrate.

The optical element might be a light source chip and the different sort of optical element might be a photodetector chip. That is to say, at first the light source chip is bonded to the substrate according to the alignment process of the present invention and then the photodetector chip is bonded to the substrate in order according to the alignment process of the present invention.

Preferably, a sort of optical element and a different sort of optical element therefrom are comprised of a plurality of chips.

As the optical element might be comprised of a plurality of chips, a plurality of light source chips could be aligned at a time with the optical axis of the light transferred through the optical waveguide from the external light source and could be bonded to the substrate.

Similarly, as the different sort of optical element might be comprised of a plurality of chips, a plurality of photodetector chips could be aligned at a time with the optical axis of the incident light emitted from the light source chips which are applied by power, preferably external power and could be bonded to the substrate.

Preferably, the step of aligning in the fabrication method of an optical module according to an embodiment of the invention can be performed by using the obtained images through an apparatus for obtaining image between the substrate and the optical element before bonding.

Preferably, the apparatus for obtaining image can be a camera and so on, and has the same wavelength as the wavelength of an external light source.

Preferably, the optical element is bonded to the substrate by any one material selected from a solder, conductive epoxy, or an anisotropic conductive film.

Preferably, the substrate is at least one board that is selected from a flexible optoelectronic wiring board, a rigid optoelectronic wiring board, a planar integrated circuit, and an optical system in (on) packaging.

Preferably, the optical waveguide is formed on the upper portion, the lower portion, or the inside of the substrate.

Preferably, the external light source incident upon the optical waveguides is positioned at the upper part, the lower part, or the side part of the optical waveguides.

According to another aspect of the embodiment of the invention, there is provided an optical module using the same fabrication method, the optical module comprising: a substrate that includes an optical waveguide transferring the light emitted from an external light source, a light emission portion allowing the transferred light to be emitted to the outside of the substrate, and electric wirings; a plurality of integrated circuit devices that are bonded to the upper portion or the lower portion of the substrate; an optical element that is formed on the substrate by the mixed/hybrid alignment method, i.e. the active and passive alignment method, according to the same fabrication method; an electrical interface that is connected to the electric wirings of the substrate; and a mixed optical/electrical connector that is formed on one end of the substrate and is connected to an optic-electrical cable.

Preferably, the optical element might be a light source chip or a photodetector chip.

Preferably, the optical element might be comprised of a plurality of chips, that is to say, the optical element might be at least one light source chip or at least one photodetector chip.

Preferably, the external light source incident upon the optical waveguide could be positioned at the upper part, the lower part, or the side part of the optical waveguide.

Preferably, the optical waveguide has at least one slanted surface formed on one end or both ends of core portions to which the light can be transferred and emitted to the outside of the substrate. When the light can be transferred from the external light source positioned at the side part of the optical waveguide and emitted to the outside of the substrate, the optical waveguide could have one slanted surface formed on one end of core portion connected to the light emission portion.

On the other hand, according to another aspect of an embodiment of the invention, there can be provided an optical module packaging system using the same fabrication method, the optical module packaging system comprising: a substrate that includes an optical waveguide; an external light source that emits light to the optical waveguide; a pickup tool that picks up an optical element, for example a light source chip or a photodetector chip, and a integrated circuit device; and an apparatus for obtaining image, for example a camera, that aligns the light emitted by the external light source with the optical element and the integrated circuit device picked up by the pickup tool.

Preferably, the external light source has the same wavelength as the wavelength of the apparatus for obtaining image.

In accordance with an embodiment of the invention, the external light source is added to the optical module packaging system in the passive alignment method according to the related art, making it possible to improve the mass productivity that is the advantage of the passive alignment method and alignment accuracy by the external light source.

Moreover, an embodiment of the invention is based on a pick and place method of the passive alignment method, making it possible to reduce packaging process and entire fabrication process time and costs thereof.

Further, with an embodiment of the invention, various substrates such as a planar integrated circuit, an optical rigid or flexible printed circuit board, an optical system in (on) packaging board, etc., can be constituted, making it possible to be used in various application fields such as an optical module for a server, an optical module for a computer, an optical module for a portable terminal, a mixed optical/electrical cable (optical display port, optical USB, optical HDMI, optical DVI, optical 1394 cable, etc.), etc.

### BRIEF DESCRIPTION OF THE DRAWINGS

FIG. 1 is a schematic cross section showing a structure where a sort of optical element is aligned using an optical alignment process in the optical module fabrication method according to one embodiment of the invention;

FIG. 2 is a plan view showing a screen that is photographed by the camera of FIG. 1 according to one embodiment of the invention;

FIG. 3 is a schematic cross section showing a structure where a different sort of optical element from the optical element of FIG. 1 is aligned using an optical alignment process in the optical module fabrication method according to one embodiment of the invention;

FIG. 4 is a plan view showing a screen that is photographed by the camera of FIG. 3 according to one embodiment of the invention;

FIG. 5 is a schematic cross section showing an optical alignment process in the optical module fabrication method according to another embodiment of the invention that aligns a different sort of optical element from the said optical element using an external power supply;

FIG. 6 is a plan view showing a screen that is photographed by the camera of FIG. 5 according to another embodiment of the invention;

FIG. 7 is a schematic cross section showing a substrate to which a plurality of optical elements according to one embodiment of the invention are attached; and

FIGS. 8 and 9 are schematic cross sections showing optical modules manufactured according to another embodiment of the invention.

### DETAILED DESCRIPTION OF THE INVENTION

Hereinafter, exemplary embodiments of the invention will be described in detail with reference to the accompanying drawings. In referring to reference numerals to components of each drawing, the same components are referred to by the same reference numerals as much as possible even if they are shown in different figures. Detailed descriptions of well-known techniques are omitted so as not to obscure the description of the invention with unnecessary detail.

The embodiment of the invention, which adds an external light source to a flip chip bonding apparatus that is a passive alignment apparatus according to the related art, uses an external light source instead of an electrode or a mark having a predetermined error between the central portion of an optical waveguide according to the related art to set the central portion of an optical waveguide to which light emitted from the external light source is transferred itself to an optical axis, making it possible to improve optical coupling efficiency and accuracy in the bonding position.

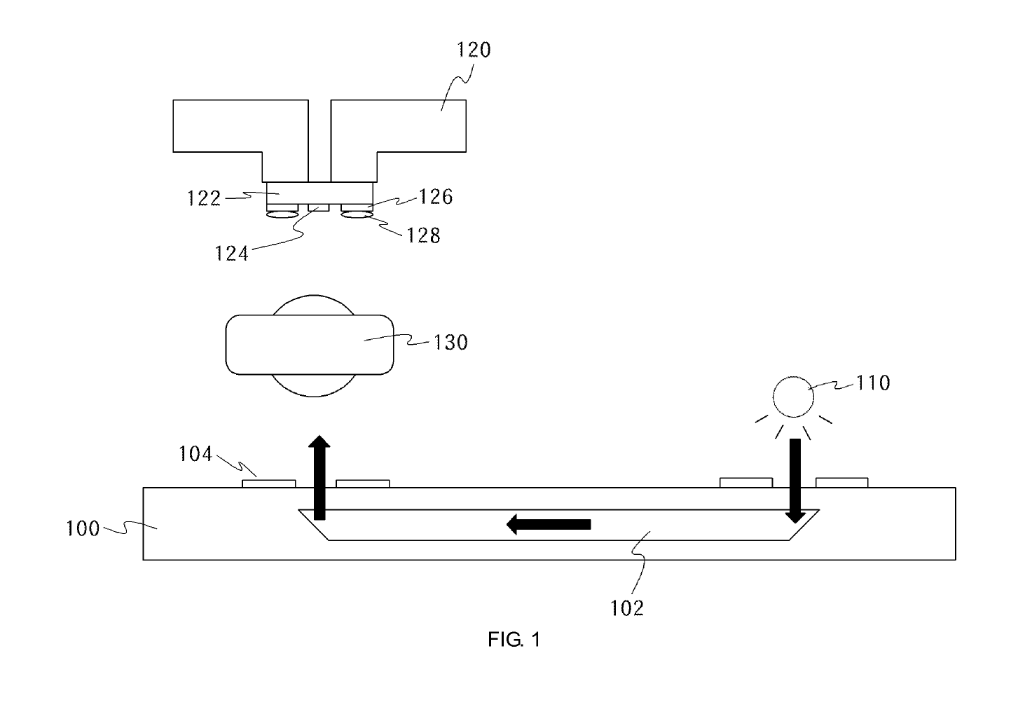

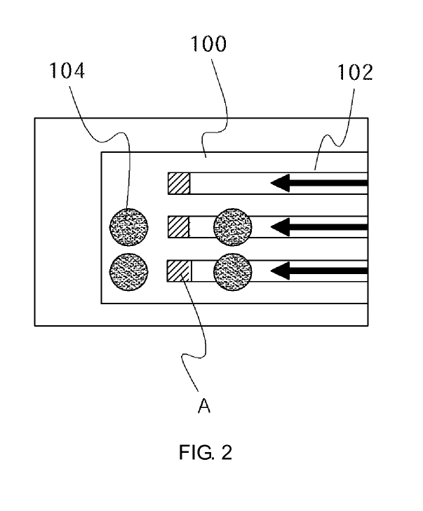

FIG. 1 is a schematic cross section showing a structure where a sort of optical element such as a light source chip is aligned using an optical alignment process in the optical module fabrication method according to one embodiment of the invention. Also FIG. 2 is a plan view showing a screen that is photographed by the camera of FIG. 1 according to one embodiment of the invention.

Referring to FIG. 1, a substrate 100, an external light source 110, a pickup tool 120, a light source chip 122, and a camera 130 are included.

The substrate 100 is provided with an optical waveguide 102 or an optical fiber, etc. and is preferably able to use at least one substrate selected from a flexible optoelectronic wiring board, a rigid optoelectronic wiring board, a planar integrated circuit, and an optical system in (on) packaging board.

Electric wirings are formed on the upper portion and the lower portion of the substrate 100, and bonding pads 104 to which a solder 128 for bonding the light source chip 122 contacts are formed around the portions to which the light transferred through the optical waveguide 102 is emitted.

The optical waveguide 102 is formed on the upper portion, the lower portion, or the inside of the substrate 100, wherein the optical waveguide 102 is formed in the inside of the substrate 100 in FIG. 1.

The optical waveguide 102 formed in the inside of the substrate 100 forms slanted surfaces on both ends of the core portions to which the light can be transferred to form a mirror (not shown) so that the light entering one end of the optical waveguide 102 can be emitted through the other end thereof. And, although the angle of the slanted surface is not limited, it is preferable to be formed at 45°.

The bonding pads 104 are bonded to the light source chip 122, wherein the bonding pads 140 may be formed on both sides based on the position to which the light is emitted so that the light emitted through the slanted surfaces of the optical waveguide 102 are aligned with the light emitting surface 124 of the light source chip 122.

The bonding pads 104 are connected to the electric wirings formed on the substrate 100 to connect the light source chip 122 electrically to the electric wirings, wherein they may be formed in electrodes.

The external light source 110 is positioned on the upper portion of the slanted surface of the other end of the optical waveguide 102 existing on the lower portion of the position of the light source chip 122 in order to accurately align the light source chip 122 so that the light emitted from the external light source 110 can be transferred to the light source chip 122 through the optical waveguide 102.

At this time, the light emitted from the external light source 110 is transferred through the optical waveguide 102, and the light can be aligned with the light emitting surface 124 of the light source chip through the camera 130 using the transferred light as a medium.

The pickup tool 120, which can use a pickup tool that is used in the passive alignment method according to the related art as it is, picks up the light source chip 122.

And, the pickup tool 120 that picks up the light source chip 122 can align the light emitted from the external light source 110 and transferred through the optical waveguide 102 and the light emitting surface 124 of the central portion of the light source chip 122.

The light source chip 122 includes the light emitting surface 124 on the central portion thereof, wherein an electrode 126 and a solder 128 are stacked sequentially on both sides of the light emitting surface 124 so that they can be bonded to the bonding pads 104 formed on the upper portion of the substrate 100.

At this time, an expensive alignment mark process as in the passive alignment method used in the related art is not performed on the lower portion of the light source chip 122 but the light emitting surface 124 on the central portion is aligned with the light transferred from the optical waveguide 102, making it possible to reduce process costs and to improve efficiency.

The camera 130 can photograph up and down in order to align the light transferred from the optical waveguide 102 with the light emitting surface 124 of the light source chip 122, wherein the used wavelength may vary according to the external light source 110.

For example, when the wavelength of the light emitted from the external light source 110 is visible rays, the camera 130 may be constituted to photograph a visible ray region, wherein, more preferably, red laser having a bandwidth of 600 nm is used as the external light source 110 and the camera 130 that can photograph the laser may be used.

Referring to FIG. 2, an image that the substrate 100 positioned under the camera 130 is photographed by the camera 130 is shown using a monitor screen, wherein it can be appreciated the positions of the bonding pads 104 that are bonded to the portion that the light is transferred through the optical waveguide 102 and is emitted to the outside of the substrate 100, that is, the portion (A) that the external light transferred through the optical waveguide 102 is emitted, and the light source chip 122. Although three optical waveguides 102 are used in FIG. 2, the number of the optical waveguides 102 that can be used in one substrate 100 is not limited to FIG. 2 but a number of the optical waveguides may be formed according to a user.

Reviewing the active and passive optical alignment method with reference to FIG. 1, the light is emitted to the optical waveguide 102 using the external light source 110 and the light source chip 122 is picked up using the pickup tool 120.

And, the camera 130 is inserted between the pickup tool 120 and the substrate 100 including the optical waveguide 102, and the light transferred through the optical waveguide 102 is aligned with the light emitting surface 124 of the light source chip 122 picked up by the pickup tool 120 so that they correspond to each other by photographing up and down using the camera 130, while moving the pickup tool 120.

If the alignment is completed, the camera 130 is removed and the pickup tool 120 is pulled down to bond the solder 128 of the light source chip 122 to the bonding pad 104 formed on the upper portion of the substrate 100, thereby forming the light source chip 122 on the accurate position of the substrate 100.

At this time, the solder 128 may be replaced by conductive epoxy or an anisotropic conductive film (ACF), etc. and can connect the light source chip 122 electrically to the substrate 100.

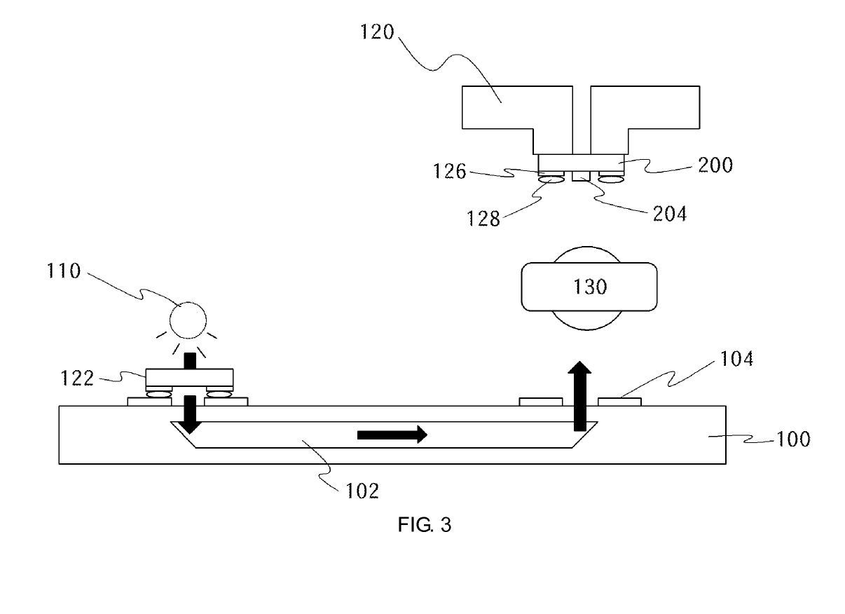

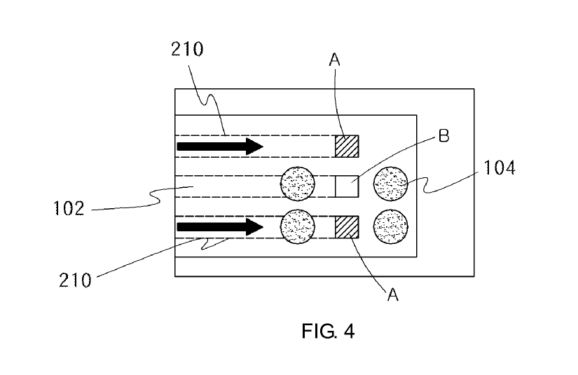

FIG. 3 is a schematic cross section showing a structure where a different sort of optical element such as a photodetector chip from the optical element of FIG. 1 is aligned using an optical alignment process in the optical module fabrication method according to one embodiment of the invention. Also FIG. 4 is a plan view showing a screen that is photographed by the camera of FIG. 3 according to one embodiment of the invention.

Referring to FIGS. 3 and 4, it is a method to form a photodetector chip 200 on the substrate 100 on which the light source chip 122 is formed, wherein after the photodector chip 200 is picked up using the pickup tool 120, the light emitted from the external light source 110 to be transferred through redundant optical waveguides 210 and the light receiving surface 240 of the photodetector chip 200 are aligned using the camera 300 and then the photodetector chip 200 is moved, thereby making it possible to bond the photodetector chip 200 to the substrate 100 including the optical waveguide 102.

The process as described above is similar to the process to form the light source chip 122 of FIG. 1. However, in the case of the optical waveguide 102 where the light source chip 122 is already formed, if external power is not applied to the light source chip 122, the light transferred through the optical waveguide 102 does not exist (B), such that after the photodetector chip 200 is aligned using light (A) emitted through redundant optical waveguides 210 formed around the optical waveguide 102 to be bonded, having a predetermined distance, the photodetector chip 200 is moved again at a predetermined distance, thereby making it possible to bond the photodetector chip 200 to the substrate 100 including the optical waveguide 102.

At this time, the interval between the redundant optical waveguides 210 and the optical waveguide 102 to which the photodetector chip 200 is to be bonded is very precise to be submicron or less, the interval being already known to the user.

As another method, the pickup tool 120 that picks up the photodetector chip 200 is not moved directly but the light emitted from the redundant optical waveguides 210 formed on both sides of the optical waveguide 102 in the substrate to which the photodetector chip 200 is to be bonded is detected by a program that controls the movement of the pickup tool 120, thereby making it possible to align the photodetector chip 200 at the center of the detected light.

In the method shown in FIGS. 3 and 4, the redundant optical waveguides are indispensable and it is very simple to manufacture the redundant optical waveguides when forming the optical waveguide on the substrate, the redundant optical waveguides having been commonly used for protecting the main optical waveguide.

Although the photodetector chip 200 is bonded after the light source chip 122 is bonded in FIGS. 1 and 2, and FIGS. 3 and 4, the order is not limited thereto but the light chip 122 can be bonded after the photodetector chip 200 is bonded.

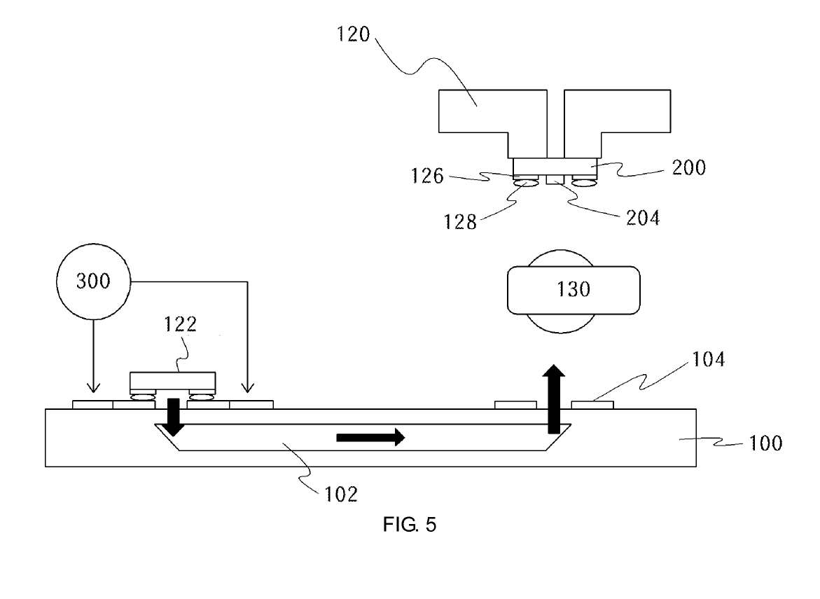

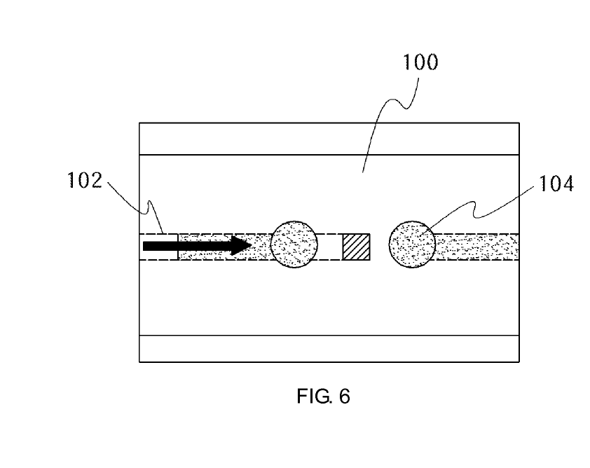

FIG. 5 is a schematic cross section showing an optical alignment process in the optical module fabrication method according to another embodiment of the invention that aligns a different sort of optical element such as a photodetector chip from the said optical element using an external power supply. Also FIG. 6 is a plan view showing a screen that is photographed by the camera of FIG. 5 according to another embodiment of the invention.

FIGS. 5 and 6 show the structure where the light generated from the light source chip 122 is transmitted through the optical waveguide 102 by applying external power 300 to the light source chip 122, wherein the light transferred through the optical waveguide 102 and the light receiving surface 204 of the photodetector chip 200 are aligned, thereby making it possible to be bonded to the substrate 100.

FIGS. 5 and 6 show the method to bond the photodetector chip 200 as shown in FIGS. 3 and 4, the method can be used when the redundant optical waveguides 210 do not exist. However, this method is troublesome in that the external power 300 should be applied to the light source chip 122 and is disadvantageous in that it is hardly used when the wavelength of the light source is different from the wavelength region of the camera. However, these problems can be solved by the automation of the external power applying apparatus and the coincidence between the light source wavelength region and the camera wavelength region.

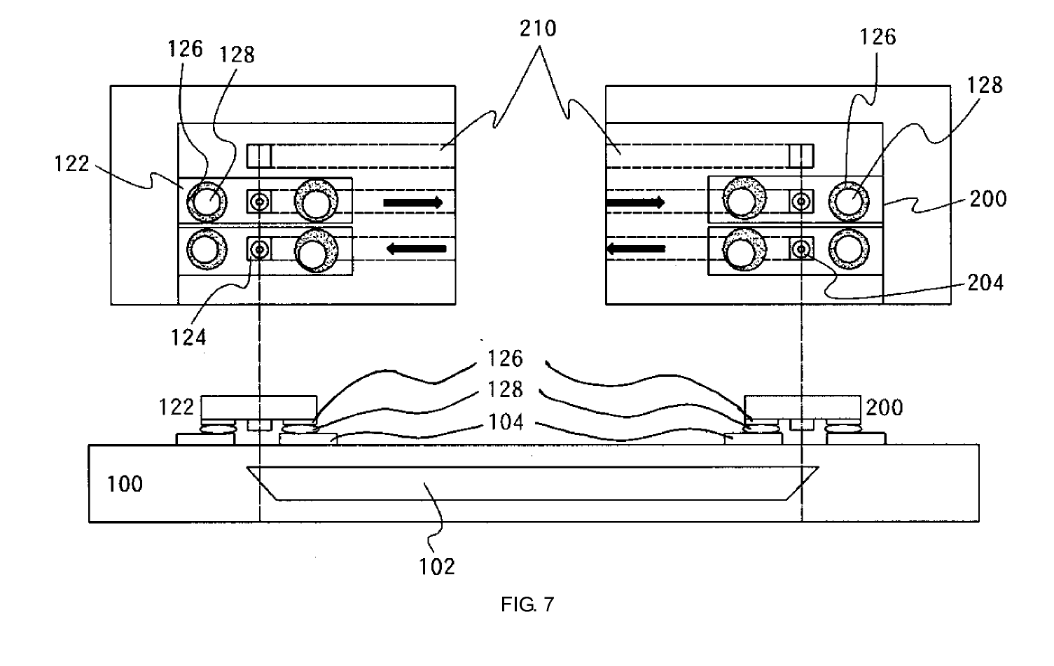

FIG. 7 is a schematic cross section showing a substrate to which a plurality of optical elements such as light source chips and photodetectors according to one embodiment of the invention are attached, wherein the light source chips and the photodetector chips are bonded several times in the methods mentioned in FIGS. 1 and 2, FIGS. 3 and 4, and FIGS. 5 and 6, and then are viewed from the upper surface and the side surface.

Referring to FIG. 7, the light emitting surface 124 of the light source chip 122 or the light receiving surface 204 of the photodetector chip 200 can be accurately aligned on the slanted surface of the optical waveguide 102, that is, on the center of the mirror formed at 45°.

At this time, a little space may occur between the center of the bonding pads 104 and the center of the solder 128 or the electrode 126 of the light source chip 122 or the photodetector chip 200, but the damage in electrical signal connection due to the space is not generated.

And, although a plurality of single chip optical elements of the light source chip 122 and the photodetector chip 200 are bonded in FIG. 7, the embodiment of the invention is not limited thereto but array chip optical elements may be bonded to the substrate 100.

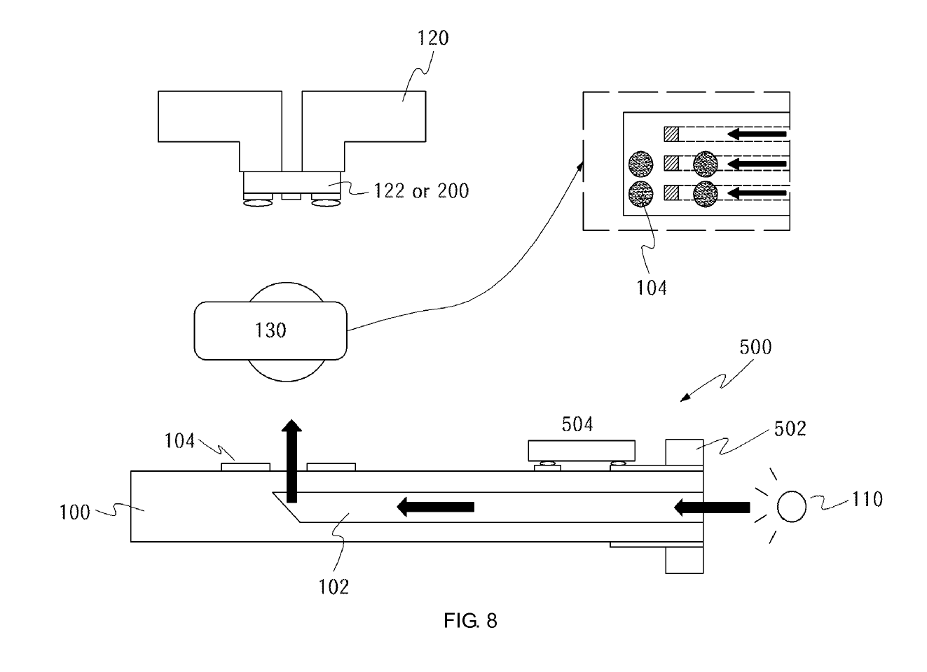

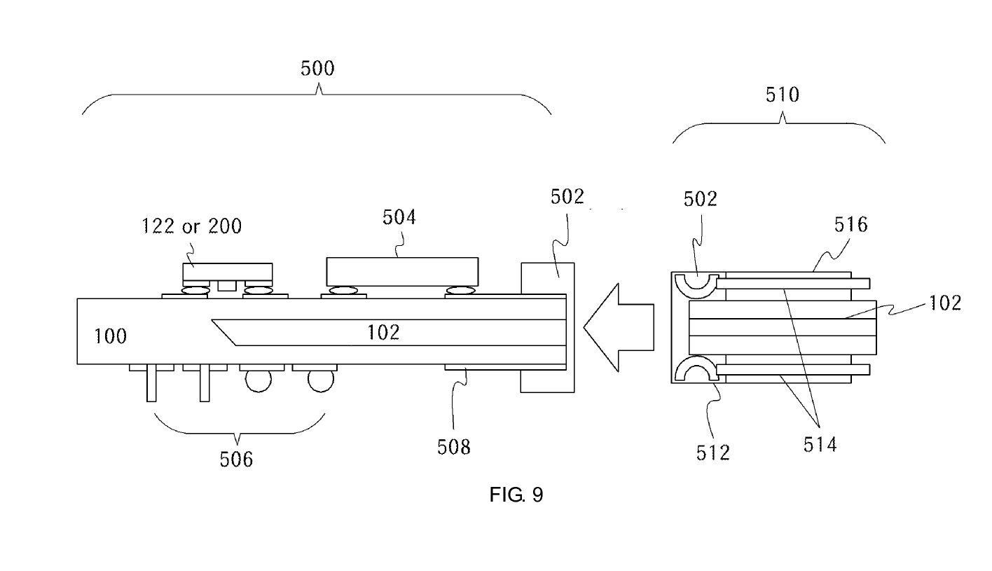

FIGS. 8 and 9 are schematic cross sections showing optical modules manufactured according to another embodiment of the invention.

Referring to FIG. 8, when one end of the optical waveguide 102 contacts one end of the substrate 100, a mixed optical/electrical connector 502 is formed on the bonded portion and an integrated circuit device 504 is formed on the upper portion of the substrate 100, thereby making it possible to manufacture the optical module.

At this time, the method used in FIGS. 1 and 4 can be used for forming the light source chip 122 or the photodetector chip 200, but the external light source may be formed on the portion where one end of the optical waveguide 102 contacts one end of the substrate 100, that is, on the side surface.

The optical module 500 with the built in mixed optical/electrical connector 502 manufactured in FIG. 8 can be used by being connected directly to a cable 510 where an external optical fiber or the optical waveguide 102 are mixed with electric wirings (see FIG. 9).

Therefore, the miniaturized and integrated optical module 500 can be manufactured in various shapes to be used and can be applied to various products by simultaneously interfacing electricity and optics to be used.

Those skilled in the art will appreciate that various modifications and variations can be made in the present invention without departing from the spirit or scope of the inventions. Also, the substances of each constituent explained in the specification can be easily selected and processed by those skilled in the art from the well-known various substances. Also, those skilled in the art can remove a part of the constituents as described in the specification without deterioration of performance or can add constituents for improving the performance. Furthermore, those skilled in the art can change the order to methodic steps explained in the specification according to environments of processes or equipment. Thus, it is intended that the present invention covers the modifications and variations of this invention provided they come within the scope of the appended claims and their equivalents.

What is claimed is:

1-16. (canceled)

17. A fabrication method of an optical module comprising:
aligning the center of a sort of optical element with the optical axis of the light transferred through an optical waveguide from an external light source and emitted to the outside of a substrate;
bonding the optical element to the substrate;
aligning the center of a different sort of optical element from the optical element with the optical axis of the incident light transferred through redundant optical waveguides formed around the optical waveguide having a predetermined distance from an external light source and emitted to the outside of the substrate; and
moving the different sort of optical element up to the predetermined distance and bonding the different sort of optical element to the substrate which the optical waveguide is situated in.

18. The fabrication method of an optical module according to claim 17, wherein the optical element is a light source chip and the different sort of optical element is a photodetector chip, or the optical element is a photodetector chip and the different sort of optical element is a light source chip.

19. The fabrication method of an optical module according to claim 17, wherein the step of aligning is performed by using the obtained images through an apparatus for obtaining image, which has the same wavelength as the wavelength of an external light source, between the substrate and the optical element before bonding.

20. The fabrication method of an optical module according to claim 17, wherein the substrate is at least one substrate that is selected from a flexible optoelectronic wiring board, a rigid optoelectronic wiring board, a planar integrated circuit, and an optical system in (on) packaging.

21. The fabrication method of an optical module according to claim 17, wherein the optical waveguides are formed on the upper portion, the lower portion, or the inside of the substrate.

22. The fabrication method of an optical module according to claim 17, wherein the external light source incident upon the optical waveguides is positioned at the upper part, the lower part, or the side part of the optical waveguides.

23. A fabrication method of an optical module comprising:
aligning the center of a sort of optical element with the optical axis of the light transferred through an optical waveguide from an external light source and emitted to the outside of a substrate;
bonding the optical element to the substrate;
applying power to the optical element and allowing the emitted light to be incident through the optical waveguide;
aligning the center of a different sort of optical element from the optical element with the optical axis of the incident light emitted to the outside of the substrate; and
bonding the different sort of optical element to the substrate.

24. The fabrication method of an optical module according to claim 23, wherein the optical element is a light source chip and the different sort of optical element is a photodetector chip.

25. The fabrication method of an optical module according to claim 23, wherein the step of aligning is performed by using the obtained images through an apparatus for obtaining image, which has the same wavelength as the wavelength of an external light source, between the substrate and the optical element before bonding.

26. The fabrication method of an optical module according to claim 23, wherein the substrate is at least one substrate that is selected from a flexible optoelectronic wiring board, a rigid optoelectronic wiring board, a planar integrated circuit, and an optical system in (on) packaging.

27. The fabrication method of an optical module according to claim 23, wherein the optical waveguides are formed on the upper portion, the lower portion, or the inside of the substrate.

28. The fabrication method of an optical module according to claim 23, wherein the external light source incident upon the optical waveguides is positioned at the upper part, the lower part, or the side part of the optical waveguides.

29. An optical module using the fabrication method, the optical module comprising:
a substrate that includes an optical waveguide transferring the light emitted from an external light source, a light emission portion allowing the transferred light to be emitted to the outside of the substrate, and electric wirings;
a plurality of integrated circuit devices that are bonded to the upper portion or the lower portion of the substrate;
an optical element that is formed on the substrate by the process according to the claim selected from claim 17;
an electrical interface that is connected to the electric wirings of the substrate; and
a mixed optical/electrical connector that is formed on one end of the substrate and is connected to an optic-electrical cable.

30. The optical module according to claim 29, wherein the optical element is a light source chip or a photodetector chip.

31. The optical module according to claim 29, wherein the external light source incident upon the optical waveguide is positioned at the upper part, the lower part, or the side part of the optical waveguide.

32. The optical module according to claim 29, wherein the optical waveguide has at least one slanted surface formed on one end or both ends of core portions to which the light can be transferred and emitted to the outside of the substrate.

33. An optical module using the fabrication method, the optical module comprising:
a substrate that includes an optical waveguide transferring the light emitted from an external light source, a light emission portion allowing the transferred light to be emitted to the outside of the substrate, and electric wirings;
a plurality of integrated circuit devices that are bonded to the upper portion or the lower portion of the substrate;
an optical element that is formed on the substrate by the process according to the claim selected from claim 23;
an electrical interface that is connected to the electric wirings of the substrate; and
a mixed optical/electrical connector that is formed on one end of the substrate and is connected to an optic-electrical cable.

34. The optical module according to claim 33, wherein the optical element is a light source chip or a photodetector chip.

35. The optical module according to claim 33, wherein the external light source incident upon the optical waveguide is positioned at the upper part, the lower part, or the side part of the optical waveguide.

36. The optical module according to claim 33, wherein the optical waveguide has at least one slanted surface formed on one end or both ends of core portions to which the light can be transferred and emitted to the outside of the substrate.
